(19) United States
(12) Patent Application Publication
(10) Pub. No.: US 2005/0021623 A1
(43) Pub. Date: Jan. 27, 2005

(54) Computer-implemented system for matching parties and subsequent automatic notification to matched parties

(76) Inventors: Syed Mike Ahmed, Blue Ash, OH (US); Wayne R. Bradshaw, Liberty Township, OH (US)

Correspondence Address: LAFKAS PATENT LLC, 7811 LAUREL AVENUE, CINCINNATI, OH, 45243, US

(21) Appl. No.: 10/840,024

(22) Filed: May 6, 2004

Related U.S. Application Data
(60) Provisional application No. 60/468,424, filed on May 7, 2003.

(51) Int. Cl. G06F 15/16

(52) U.S. Cl. 709/204

(57) ABSTRACT

The present invention is a system and method for matching employers with employees by way of the Internet using standardized formats for inputting qualifications and desired abilities, comparing the qualifications and abilities of employees with those wanted by an employer, scoring the comparison and notifying the employer and/or employee of a match if their qualifications and abilities match those desired by the employer.

### CROSS-REFERENCE TO RELATED APPLICATIONS

This application for a patent claims priority to U.S. Provisional Application No. 60/468,424 as filed May 7, 2003.

### BACKGROUND

1. Field of the Invention

The present invention pertains to the field of matching two or more parties having similar interests, and more particularly, relates to matching recruiters and potential employees.

2. Discussion of the Prior Art

One of the primary challenges in the staffing industry is to match potential candidates with potential job openings. Often a recruiter must manually review hundreds of resumes, applications and other related documents and assess the potential employees' skills in view of hundreds of potential employers' needs. The recruiter often finds himself with a matrix containing the various technical aspects of potential employees and the various elements desired in an employee by potential employers.

To add further complications to the matter, there is not a standard format of candidate credentials and resumes submitted by potential candidates or a standardized form used by potential employers to identify the qualities wanted from an employee. Thus, the recruiter must take extra time to search out the needed information on each paper submitted by a potential employee and potential employer before a match can be made between a potential employee and potential employer.

Even when reviewing a resume, however, there may be a question regarding the integrity of the information provided by a potential employee. It is not uncommon for a potential employee to embellish and/or enhance his/her qualifications.

Recruiters may typically not be privy to certain employment openings and/or potential employees searching for positions. Thus, some recruiters may not be in as large of a pool of information about potential employers and potential employees as would be desired.

Further, once a recruiter manually makes a match between a potential employee and potential employer, the recruiter may end up serving as a “middle-man” between the potential employee and potential employer. Having such a “middle-man” may slow the reviewing, interviewing and/or employment-offering process, as well as add expenses.

Thus, what is needed is a system for pooling reliable and updated information about potential employees and potential employers using a standard format and allowing for direct notification to potential employees and potential employers of employment opportunities matching their respective qualifications.

### SUMMARY

The various exemplary embodiments of the present invention comprise a computer-implemented system for assisting potential acquirees and potential acquirers to be matched together based on one or more sets of criteria, the system comprising: one or more computers, wherein the one or more computers are connected via Internet; one or more databases stored on the one or more computers comprising information, wherein the information is one or more sets of desired criteria respective of the one or more potential acquirers and one or more sets of actual criteria respective of the one or more potential acquirees; one or more computer interfaces, wherein one or more persons representing the one or more potential acquirees inputs the one or more actual criteria respective of the one or more potential acquirees via the one or more computer interfaces, such that the one or more actual criteria respective of the one or more potential acquirees is input as a pre-determined standardized format; wherein one or more persons representing the one or more potential acquirers inputs the one or more desired criteria respective of the one or more potential acquirers via the one or more computer interfaces, such that the one or more desired criteria respective of the one or more potential acquirers is input as a pre-determined standardized format; an automatic matching means, wherein the one or more desired criteria of the one or more potential acquirers and the actual criteria of the one or more potential acquirees are compared to each other, scored on a weighted scale, and matched if a score between the desired criteria and the actual criteria is greater than or equal to a pre-determined value; and an automatic notification means, wherein each of the one or more potential acquirers and the one or more potential acquirees are notified if a score between the desired criteria and the actual criteria is greater than or equal to the pre-determined value.

The various exemplary embodiments of the present invention further comprise a method for matching one or more potential acquirees and one or more potential acquirers via a computer-implemented system, comprising: inputting one or more sets of desired criteria respective of the one or more potential acquirers, wherein the one or more desired criteria are input as a pre-determined standardized format; inputting one or more sets of actual criteria respective of the one or more potential acquirees, wherein the one or more actual criteria are input as a pre-determined standardized format; comparing the one or more sets of desired criteria input and the one or more sets of actual criteria, and determining a score of a comparison between the one or more sets of desired criteria input and the one or more sets of actual criteria on a weighted scale; determining a match between the one or more sets of desired criteria input and the one or more sets of actual criteria if the score is greater than or equal to a pre-determined value; and notifying the one or more potential acquirers and the one or more potential acquirees if the score is greater than or equal to a pre-determined value.

### DESCRIPTION

In the various exemplary embodiments of the present invention, a computer-implemented system assists potential acquirees and potential acquirers to be matched together based on their respective expertise and/or products and needs and/or desires.

A potential acquirer may be, for example, an individual, a company, a non-profit organization, a government entity, and the like. The one or more potential acquirers may be seeking to employ an individual, hire a contractor, or purchase goods.

A potential acquiree may be, for example, an individual, a company, a non-profit organization, a government entity, and the like. The one or more potential acquirees may be seeking to volunteer, be employed or seeking to sell goods.

The computer-implemented system of the various exemplary embodiments comprises one or more computers connected to the Internet and one or more databases stored on one or more computers. The databases comprise information, wherein the information is one or more sets of criteria related to each of the one or more potential acquirees and the one or more potential acquirers.

In the various exemplary embodiments of the present invention, the computer-implemented system further comprises one or more computer interfaces. The one or more computer interfaces of the various exemplary embodiments allows for one or more persons representing the one or more potential acquirees to input actual criteria associated with the one or more potential acquirees, that is, for example, the work experience, technical skills, or detailed product description, into the computer-implemented system.

The one or more computer interfaces of the various exemplary embodiments allows for one or more persons representing the one or more potential acquirers to input desired criteria of the one or more potential acquirers, that is, for example, the work experience desired of an employee or contractual hire, technical skills desired of an employee or contractual hire, or detailed preferred product description, into the computer-implemented system.

One or more persons representing the one or more potential acquirees in the various exemplary embodiments can be, for example, the one or more potential acquirees, a broker, a recruiter, or other third party. The one or more persons representing the one or more potential acquirers in the various exemplary embodiments can be, for example, the one or more potential acquirers, a broker, a recruiter, or other third party.

In preferred embodiments of the present invention, the one or more persons representing the one or more potential acquirees and the one or more persons representing the one or more potential acquirers are not the same individual.

In various exemplary embodiments of the present invention, it is preferred that the one or more persons representing the one or more potential acquirees are not the one or more potential acquirees when the computer-implemented system is for filling staffing and/or employment needs of a potential acquirer. It is preferred that the one or more persons representing the one or more potential acquirees is a third party in order to provide a greater assurance of the integrity of the information regarding the one or more potential acquirees. That is, the one or more persons, as a third party, is presumed to review the accuracy of the actual criteria regarding the one or more potential acquirees.

In the various exemplary embodiments, it is preferred that the actual and desired criteria are input into the computer face in a pre-determined standardized format for one or more particular industries, technical fields of concentration, or companies.

Upon inputting the actual criteria of a potential acquiree and/or the desired criteria of a potential acquirer, an automatic matching means compares and/or contrasts the actual criteria and desired criteria to each other. The automatic matching means of the various exemplary embodiments then provides a score based on a weighted scale of the relation between one or more comparisons and/or contrasts of the actual criteria and the desired criteria. The weighted scale is pre-determined based on, for example, a standard weighing of one or more criteria values, a weighing of one or more criteria values set by the one or more persons representing the one or more potential acquirers, or combinations thereof.

The automatic matching means in various exemplary embodiments comprises artificial intelligence to provide matching between actual criteria and desired criteria.

The automatic matching means of the various exemplary embodiments, unlike manual review by a recruiter, is able to work twenty-four hours a day, seven days a week.

If the score between the actual criteria and the desired criteria is greater than or equal to a pre-determined value, in the various exemplary embodiments of the present invention, a match is deemed to occur.

The score in the various exemplary embodiments of the present invention is in the form of, for example, a numeric value, a percentage, a fraction, a letter grade, a textual message, a symbol, or a combination thereof.

Upon the occurrence of a match, an automatic notification means contacts each of the one or more potential acquirers of the actual criteria of one or more potential acquirees input into the computer-implemented system. Further, the automatic notification means contacts each of the one or more potential acquirees of the desired criteria of the one or more potential acquirers input into the computer-implemented system if a match is deemed to occur.

In the various exemplary embodiments, the automatic notification means is an electronic message (“e-mail”) sent to the electronic address (“e-mail address”) of each of the one or more potential acquirers and one or more potential acquirees.

The automatic notification means to the one or more potential acquirers of the various exemplary embodiments may comprise the actual criteria of the one or more potential acquirees, the score between the actual criteria of the one or more potential acquirees and the desired criteria of the one or more potential acquirers, information on contacting the one or more potential acquirees, or combinations thereof.

The automatic notification means to the one or more potential acquirees of the various exemplary embodiments may comprise the desired criteria of the one or more potential acquirers, the score between the actual criteria of the one or more potential acquirees and the desired criteria of the one or more potential acquirers, information on contacting the one or more potential acquirers, or combinations thereof.

Thus, upon receiving the automatic notification, the one or more potential acquirees and/or potential acquirer can contact one another and arrange a meeting, an interview, employment contract, purchasing contract, and the like depending on the needs of each party.

In various exemplary embodiments of the present invention, the one or more actual criteria of the one or more potential acquirees are purged from the computer-implemented system after a pre-determined period of time. Purging the system assists in data integrity by ensuring the actual criteria of potential acquirees are updated and/or that potential acquirees that are employed no longer keep their actual criteria posted. In other words, the actual criteria is kept from becoming stale.

In various exemplary embodiments, the one or more desired criteria of the one or more potential acquirers are purged from the computer-implemented system after a pre-determined period of time. Purging the system of the desired criteria ensures that staffing needs that are filled and/or that sought-after goods that are purchased are no longer matched.

Purging the system of actual criteria and desired criteria after a pre-determined period of time also saves memory space on the computer-implemented system.

In the various exemplary embodiments of the present invention, the system may further comprise a rating means. The rating means allows the one or more persons representing the one or more potential acquirers to rate other persons representing potential acquirers. In another embodiment, the one or more persons representing the one or more potential acquirers may rate the one or more persons representing the one or more acquirees.

The rating system may also permit the one or more persons representing the one or more potential acquirees to rate the persons representing the one or more potential acquirers. In yet another embodiment, the one or more persons representing the one or more acquirees can rate other persons representing potential acquirees via the rating means.

The rating means of the various exemplary embodiments of the present invention allows persons accessing the system to evaluate, for example, effectiveness, speed, integrity, truthfulness, response to questions, etc. of other persons accessing the system.

The rating means according to the various embodiments according to the present invention may be responses in the form of numbers, text, symbols, yes/no answers, true/false answers, written comments, or combinations thereof.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

1. A computer-implemented system for assisting potential acquirees and potential acquirers to be matched together based on one or more sets of criteria, the system comprising:
one or more computers, wherein the one or more computers are connected via Internet;
one or more databases stored on the one or more computers comprising information, wherein the information is one or more sets of desired criteria respective of the one or more potential acquirers and one or more sets of actual criteria respective of the one or more potential acquirees;
one or more computer interfaces,
wherein one or more persons representing the one or more potential acquirees input the one or more actual criteria respective of the one or more potential acquirees via the one or more computer interfaces, such that the one or more actual criteria respective of the one or more potential acquirees is input as a pre-determined standardized format;
wherein one or more persons representing the one or more potential acquirers input the one or more desired criteria respective of the one or more potential acquirers via the one or more computer interfaces, such that the one or more desired criteria respective of the one or more potential acquirers is input as a pre-determined standardized format;
an automatic matching means, wherein the one or more desired criteria of the one or more potential acquirers and the actual criteria of the one or more potential acquirees are compared to each other, scored on a weighted scale, and matched if a score between the desired criteria and the actual criteria is greater than or equal to a pre-determined value; and
an automatic notification means, wherein each of the one or more potential acquirers and the one or more potential acquirees are notified if a score between the desired criteria and the actual criteria is greater than or equal to the pre-determined value.

2. The computer-implemented system according to claim 1, wherein the one or more sets of criteria comprises employment status, geographical location, technical skill set, cumulative experience in a particular field of work, and combinations thereof.

3. The computer-implemented system according to claim 1, wherein the pre-determined standardized format is different based on different fields of technical concentration on the part of the one or more potential acquirers and the one or more potential acquirees.

4. The computer-implemented system according to claim 1, wherein the one or more persons representing the one or more potential acquirers are the one or more potential acquirers.

5. The computer-implemented system according to claim 1, wherein the one or more persons representing the one or more potential acquirees are the one or more potential acquirees.

6. The computer-implemented system according to claim 1, wherein the automatic notification means is an electronic message notification.

7. The computer-implemented system according to claim 1, wherein the score is a numeric value.

8. The computer-implemented system according to claim 1, wherein the weighted scale is pre-determined by the one or more potential acquirers.

9. The computer-implemented system according to claim 1, wherein the one or more actual criteria respective of the one or more potential acquirees is purged from the system after a pre-determined period of time.

10. The computer-implemented system according to claim 1, wherein the one or more desired criteria respective of the one or more potential acquirers is purged from the system after a pre-determined period of time.

11. The computer-implemented system according to claim 1, further comprising a rating means for providing feedback regarding the one or more persons representing the one or more acquirers, the one or more persons representing the one or more acquirees, or both.

12. The computer-implemented system according to claim 11, wherein the rating means comprises one or more responses, wherein the one or more response are in the form of numbers, text, symbols, yes/no answers, true/false answers, written comments or combinations thereof.

13. A method for matching one or more potential acquirees and one or more potential acquirers via a computer-implemented system, comprising:
inputting one or more sets of desired criteria respective of the one or more potential acquirers, wherein the one or more desired criteria are input as a pre-determined standardized format;
inputting one or more sets of actual criteria respective of the one or more potential acquirees, wherein the one or more actual criteria are input as a pre-determined standardized format;
comparing the one or more sets of desired criteria input and the one or more sets of actual criteria, and determining a score of a comparison between the one or more sets of desired criteria input and the one or more sets of actual criteria on a weighted scale;
determining a match between the one or more sets of desired criteria input and the one or more sets of actual criteria if the score is greater than or equal to a pre-determined value; and
notifying the one or more potential acquirers and the one or more potential acquirees if the score is greater than or equal to a pre-determined value.

14. The method according to claim 13, wherein the one or more sets of criteria comprises employment status, geographical location, technical skill set, cumulative experience in a particular field of work, and combinations thereof.

15. The method according to claim 13, wherein the pre-determined standardized format is different based on different fields of technical concentration on the part of the one or more potential acquirers and the one or more potential acquirees.

16. The method according to claim 13, wherein the notifying is performed automatically without prompting by a user.

17. The method according to claim 13, wherein the notifying is performed by an electronic message notification.

18. The method according to claim 13, wherein the score is a numeric value.

19. The method according to claim 13, wherein the pre-determined value is pre-determined by the one or more potential acquirers.

20. The method according to claim 13, wherein the computer-implemented system is connected to the Internet.

21. The method according to claim 13, wherein the one or more actual criteria respective of the one or more potential acquirees is purged from the system after a pre-determined period of time.

22. The method according to claim 13, wherein the one or more desired criteria respective of the one or more potential acquirers is purged from the system after a pre-determined period of time.

23. The method according to claim 13, further comprising rating the one or more persons representing the one or more acquirers, the one or more persons representing the one or more acquirees, or both.
